(19) United States
(12) Patent Application Publication
(10) Pub. No.: US 2016/0158998 A1
(43) Pub. Date: Jun. 9, 2016

(54) IMPRINT APPARATUS AND METHOD, AND METHOD OF MANUFACTURING ARTICLE

(71) Applicant: CANON KABUSHIKI KAISHA, Tokyo (JP)

(72) Inventor: Keiko Chiba, Utsunomiya-shi (JP)

(21) Appl. No.: 14/958,233

(22) Filed: Dec. 3, 2015

(30) Foreign Application Priority Data
Dec. 8, 2014 (JP) 2014-248415
Sep. 10, 2015 (JP) 2015-178879

(51) Int. Cl. B29C 59/00; B29C 59/02

(52) U.S. Cl. CPC B29C 59/002; B29C 59/02; B29L 2031/34

(57) ABSTRACT

An imprint apparatus for forming a pattern on a substrate by bringing a mold into contact with an imprint material on the substrate is provided. The apparatus includes a supply device configured to supply, between the imprint material and the mold, a condensable gas that is liquefied due to a rise in pressure caused by the contact, and a controller configured to control a pressure of a gas between the imprint material and the mold before the contact so that the condensable gas between the imprint material and the mold is not liquefied before the contact.

### BACKGROUND OF THE INVENTION

1. Field of the Invention

The present invention relates to an imprint apparatus and method, and a method of manufacturing an article.

2. Description of the Related Art

An imprint technique is coming into practical use as one lithography technique for manufacturing an article such as a magnetic storage medium and semiconductor device.

US Patent Application Publication No. 2009/0115110 discloses a method of uniforming the residual layer thickness of the pattern of a cured imprint material in an imprint apparatus. In this method, to dispense an imprint material on a substrate by an inkjet technique, the arrangement of droplets is optimized in accordance with the density of a pattern to be transferred. By uniforming the residual layer thickness within the plane of the substrate, the dimension of the pattern, such as the line width, can be uniformed within the plane when transferring (forming) the pattern on an underlayer by dry etching or the like.

However, as described in US Patent Application Publication No. 2009/0115110, an imprint method of discretely arranging an imprint material on the substrate tends to confine bubbles between a mold and the imprint material by pressing the mold against the imprint material. If the imprint material is cured while bubbles remain, a defect (non-fill defect or unfilled defect) is undesirably generated in a formed pattern.

On the other hand, there is proposed a method of promoting extinction of bubbles by introducing (supplying), between a mold and an imprint material, a condensable gas that is liquefied (condensed) due to a rise in pressure caused by pressing the mold (Japanese Patent Laid-Open No. 2004-103817).

If a mold or substrate is moved at high speed to press it against an imprint material, a repulsive force that disturbs the high-speed movement can be generated due to a gas flow between the imprint material and the mold or substrate (Japanese Patent Laid-Open No. 2014-022527).

If a pressure generated by the repulsive force exceeds the saturated vapor pressure of a condensable gas and the condensable gas is liquefied, the condensable gas decreases. A gas other than the condensable gas then increases between the mold and the imprint material. Therefore, a gas (bubbles) confined by pressing the mold is difficult to decrease due to condensation.

### SUMMARY OF THE INVENTION

The present invention provides, for example, an imprint apparatus advantageous in accurate patterning (pattern formation) thereby.

According to one aspect of the present invention, an imprint apparatus for forming a pattern on a substrate by bringing a mold into contact with an imprint material on the substrate is provided. The apparatus comprises a supply device configured to supply, between the imprint material and the mold, a condensable gas that is liquefied due to a rise in pressure caused by the contact, and a controller configured to control a pressure of a gas between the imprint material and the mold before the contact so that the condensable gas between the imprint material and the mold is not liquefied before the contact.

Further features of the present invention will become apparent from the following description of exemplary embodiments (with reference to the attached drawings).

### BRIEF DESCRIPTION OF THE DRAWINGS

FIG. 1 a view showing the arrangement of an imprint apparatus according to the first embodiment;

FIG. 2 is a flowchart illustrating the operation procedure of the imprint apparatus according to the first embodiment;

FIG. 3 is a view for explaining filling of an imprint material on a substrate;

FIG. 4 is a view for explaining processing of controlling the pressure between a mold and the substrate according to the first embodiment;

FIG. 5 is a view for explaining processing of controlling the pressure between a mold and a substrate according to the second embodiment;

FIG. 6 is a flowchart illustrating the operation procedure of an imprint apparatus according to the second embodiment;

FIG. 7 is a view showing the arrangement of an imprint apparatus according to the fourth embodiment;

FIG. 8 is a view showing the arrangement of an imprint apparatus according to the fifth embodiment;

FIG. 9 is a table showing an example of the relationship between a condensable gas density and the relative velocity between a mold and a substrate with respect to liquefaction of a condensable gas;

FIG. 10 is a flowchart illustrating the operation procedure of the imprint apparatus according to the fifth embodiment; and

FIG. 11 is a view showing a modification of the imprint apparatus.

### DESCRIPTION OF THE EMBODIMENTS

Various exemplary embodiments, features, and aspects of the invention will be described in detail below with reference to the drawings. Note that the present invention is not limited to the following embodiments, and these embodiments are merely practical examples advantageous when carrying out the present invention. Furthermore, not all combinations of features explained in the following embodiments are essential for the present invention to solve the problem.

### First Embodiment

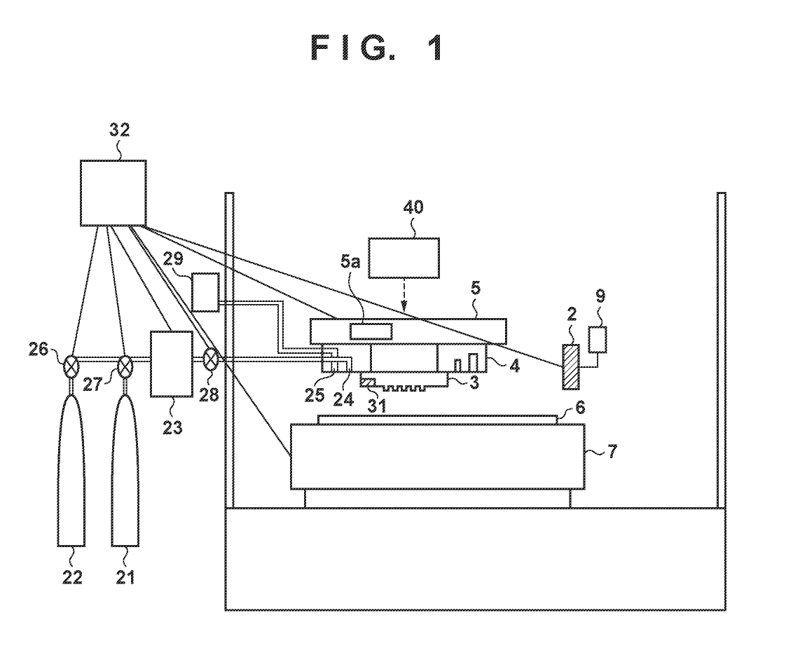

FIG. 1 shows the arrangement of an imprint apparatus according to the first embodiment. In this embodiment, the imprint apparatus adopts a photo-curing method of curing an imprint material by ultraviolet-light irradiation. The present invention, however, is not limited to this. For example, a heat-curing method of curing an imprint material by a heat input can be adopted.

Referring to FIG. 1, an illumination system 40 irradiates a mold 3 with ultraviolet light at the time of an imprint process. The mold 3 is a mold having a surface facing a substrate 6, on which a predetermined pattern has been formed. The mold 3 is made of a material such as quartz that transmits ultraviolet light. A mold holding device 4 holds the mold 3 by a vacuum attraction force or an electrostatic attraction force. A mold head 5 supports the mold holding device 4, and includes a driving device 5a for driving the mold holding device 4 toward the substrate 6 for pressing and releasing. Note that the pressing operation and releasing operation in the imprint apparatus may be implemented by moving the mold 3 but may be implemented by moving a substrate stage 7 or moving both the mold 3 and the substrate stage 7.

The substrate stage 7 holds the substrate 6 by, for example, vacuum suction. A dispenser 2 dispenses an imprint material onto the substrate by, for example, an inkjet method. The imprint material is, for example, a photo-curing composition having a property in which it is cured by receiving ultraviolet light, and can be selected, as needed, in a semiconductor device manufacturing step or the like. The imprint material is stored in a tank 9.

A gas supply device 23 supplies, to a gas supply port 24 via a valve 28, at least one of a condensable gas 21 introduced via a valve 27 and a permeable gas 22 (a gas falling outside the definition of the condensable gas) introduced via a valve 26, such as nitrogen gas for purging. In addition, a gas recovery device 29 recovers a gas from a gas recovery port 25. A pressure sensor 31 (detector) is provided in, for example, the mold 3, and detects the pressure between the mold 3 and the substrate 6. A controller 32 includes a CPU, RAM, and ROM, and comprehensively controls the overall apparatus including the above devices.

In this embodiment, the imprint apparatus is placed in, for example, an environment of 23° C. and 0.1 MPa. As the condensable gas 21, for example, 1,1,1,3,3-pentafluoropropane (CF₃CH₂CHF₂ having a saturated vapor pressure of 0.137 MPa at 23° C.) is used. 1,1,1,3,3-pentafluoropropane is stable, has low toxicity to human bodies, and has no high global warming potential.

When Pf represents the pressure of the environment in which the imprint apparatus is placed, the condensable gas 21 has, for example, a saturated vapor pressure falling within the range from Pf (exclusive) to or (Pf+0.3) MPa (inclusive). If a gas having a saturated vapor pressure exceeding (Pf+0.3) MPa is used, a pressure necessary to condense the gas is high to cause a large distortion of the mold 3 or substrate 6, thereby producing an adverse effect such as a deterioration in position accuracy of the pattern or damage to the mold. Conversely, if a gas having a saturated vapor pressure lower than the pressure Pf of the apparatus environment is used, the gas does not exist as a gas in the apparatus, thereby making it impossible to exert the effect of condensation. Practical examples of the condensable gas 21 are c-(CF₂)₄, CH₃ (CH₂)₂CH₃, CF₃CHFCF₂CF₃, CH(CF₃)₃, CH₃CF₂CF₂CF₃, CF₃CH₂CF₂CF₃, CF₃CHCH₃CF₃, CH₃CH₂CH₂CF₃, CHF₂CF₂CF₂CF₃, CF₃(CF₂)₂CF₃, CFCl₃. In consideration of stability and the like, fluorocarbons such as c-(CF₂)₄, CF₃CHFCF₂CF₃, and CHF₂CF₂CF₂CF₃ are often used.

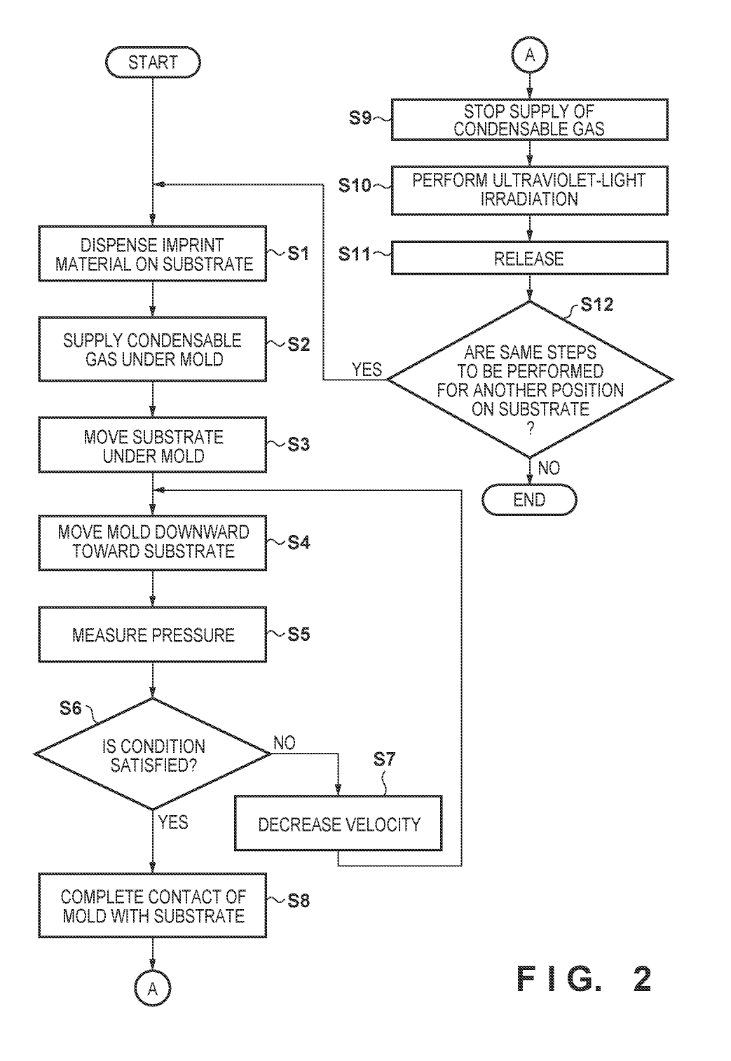

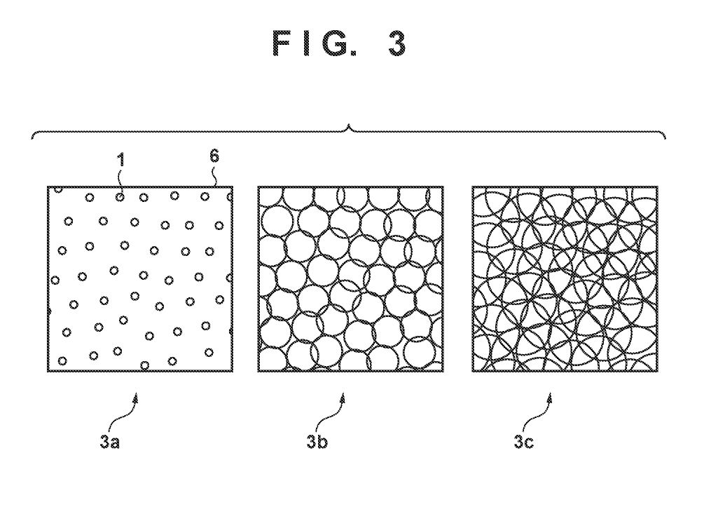

The operation of the imprint apparatus according to this embodiment will be described below with reference to a flowchart shown in FIG. 2. For example, programs corresponding to this flowchart can be stored in a memory in the controller 32 or another storage device, and executed by the controller 32. First, an imprint material 1 is dispensed on the substrate 6 using the dispenser 2 (step S1). At this time, when the substrate 6 is seen from above, droplets of the imprint material 1 are not in contact with each other, as indicated by reference numeral 3a. Next, the gas supply device 23 and the gas recovery device 29 are operated in parallel, thereby starting to supply and recover the condensable gas 21 to and from a space under the mold 3 (step S2). With the operations of the gas supply device 23 and the gas recovery device 29, a region of the substrate 6 on which the imprint material 1 has been dispensed is placed in the environment of the condensable gas 21. By placing the region in the environment of the condensable gas 21, the condensable gas 21 dissolves and diffuses in the imprint material 1. Since the dissolution/diffusion rate of the condensable gas 21 for the imprint material is high, as compared with oxygen or nitrogen in the environment, an inert gas, or the like, it is possible to make filling of the imprint material progress within a short time from a state indicated by reference numeral 3a to states indicated by reference numerals 3b and 3c. When the gas is condensed, the volume of the gas reduces, thereby preventing bubbles from remaining to generate an non-fill or unfilled defect.

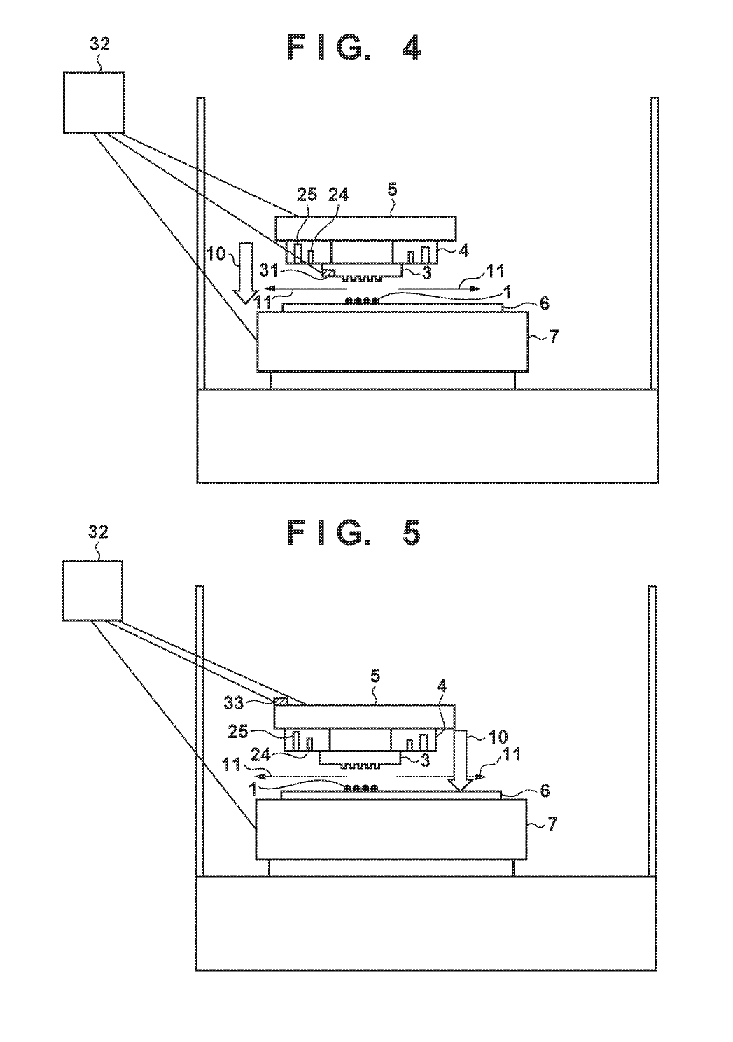

Subsequently, the substrate 6 is moved under the mold 3 by the substrate stage 7 (step S3), and the mold 3 is moved downward toward the substrate 6 by the driving device 5a of the mold head 5 (step S4). When the mold head 5 is moved in a direction indicated by an arrow 10 shown in FIG. 4 to bring the mold 3 closer to the substrate 6, the gas is pushed out, as indicated by arrows 11, thereby generating a pressure for preventing the mold 3 from being brought closer to the substrate 6. The pressure between the mold 3 and the substrate 6 before the mold is brought into contact with the imprint material is measured using the pressure sensor 31 (step S5). Based on the output of the pressure sensor 31, it is determined whether a condition is satisfied (step S6). The condition is given by:

α·(Pg−Pf)≧Pa−Pf (1)

where Pg represents the saturated vapor pressure of the condensable gas, Pf represents the pressure of the environment in which the imprint apparatus is placed, Pa represents the pressure detected by the pressure sensor 31, that is, the pressure between the mold 3 and the substrate 6 before the mold 3 is brought into contact with the imprint material, and a represents a predetermined weighting coefficient (a positive real number smaller than 1). For example, α=1/2 can be set.

If the condition given by inequality (1) is not satisfied, the measured pressure may exceed the saturated vapor pressure, and the condensable gas may be liquefied before the mold 3 and the imprint material on the substrate 6 are brought into contact with each other. To cope with this, the controller 32 controls to lower the pressure between the mold 3 and the substrate 6 so the condensable gas is not liquefied. More specifically, the controller 32 can lower the pressure by decreasing the relative velocity between the mold 3 and the substrate 6 (step S7).

After contact of the mold 3 with the substrate 6 is completed (step S8), the operations of the gas supply device 23 and the gas recovery device 29 are stopped (almost simultaneously) (step S9), and the illumination system 40 performs ultraviolet-light irradiation to cure the imprint material 1 (step S10). After that, the pattern of the imprint material 1 is formed by releasing the mold 3 from the imprint material 1 (step S11). Subsequently, it is determined whether to perform the imprint steps in steps S1 to S11 for another position on the substrate (step S12). Repeating the imprint steps molds the imprint material 1 on the entire surface of the substrate 6.

With the above-described processing, the pressure between the mold 3 and the substrate 6 is appropriately controlled so the condensable gas is not liquefied before the mold 3 and the imprint material on the substrate 6 are brought into contact with each other. This can prevent an unfilling defect from being generated, thereby improving the accuracy of pattern formation. As long as no non-fill defect is generated, it is not necessary to perform countermeasure processing for it, and thus the productivity increases.

### Second Embodiment

FIG. 5 is a schematic view showing processing of controlling the pressure between a mold and a substrate in an imprint apparatus according to the second embodiment. The same reference numerals as those in FIG. 4 of the first embodiment denote the same components. The arrangement of the imprint apparatus according to this embodiment is almost the same as in the first embodiment except that a load cell 33 is used as a detector in this embodiment, in place of the pressure sensor 31. Referring to FIG. 5, the load cell 33 is provided in a mold head 5, and configured to detect a load imposed on a mold 3. Note that the load cell 33 may be arranged in a substrate stage 7 and configured to measure a load imposed on a substrate 6.

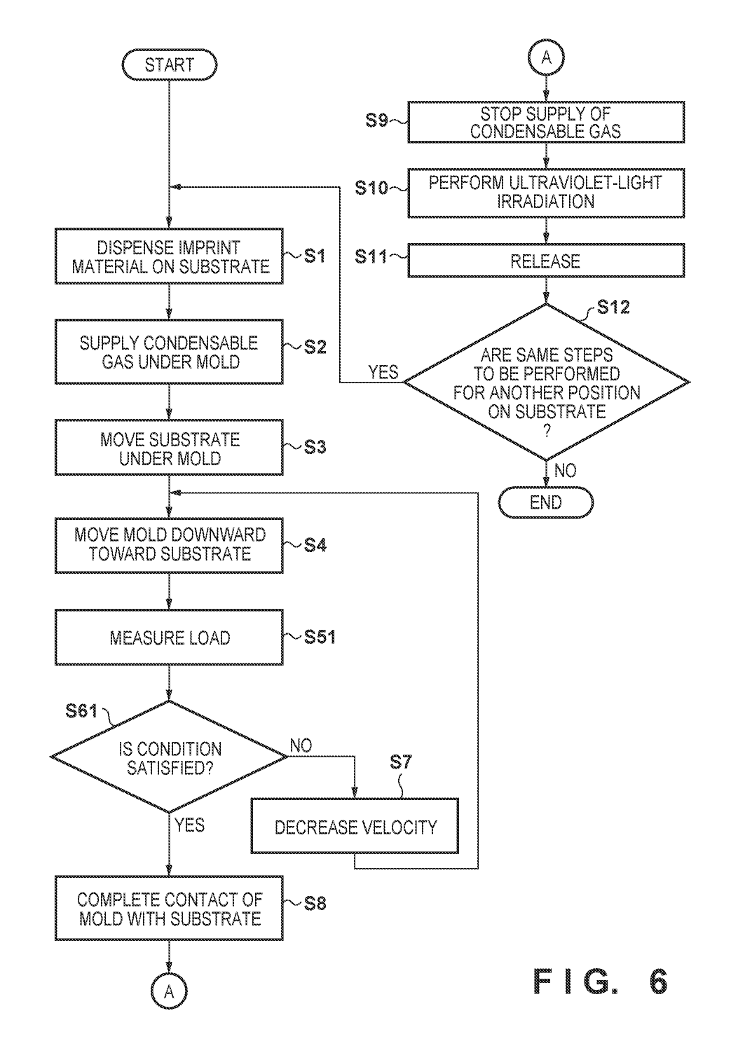

The operation of the imprint apparatus according to this embodiment will be described below with reference to a flowchart shown in FIG. 6. The same reference symbols as those in FIG. 2 of the first embodiment denote the same processing steps. A control procedure according to this embodiment is almost the same as in the first embodiment except that steps S51 and S61 are executed in this embodiment, in place of steps S5 and S6. As described above, when the mold 3 is brought closer to the substrate 6 by moving the mold head 5 by a driving device 5a in a direction indicated by an arrow 10 shown in FIG. 5, a gas is pushed out, as indicated by arrows 11, thereby generating a pressure for preventing the mold 3 from being brought closer to the substrate 6. In step S51, a load imposed on the mold 3 is measured using the load cell 33. In step S61, based on the load detected by the load cell 33, it is determined whether a condition is satisfied. The condition is given by:

α·(Pg−Pf)≧(A2−A1)/S (2)

where Pg represents the saturated vapor pressure of a condensable gas, Pf represents the pressure of an environment in which the imprint apparatus is placed, A1 represents the load imposed on the mold 3 when the distance between the mold 3 and the substrate 6 is the first distance that is sufficiently long, A2 represents the load when the distance between the mold 3 and the substrate 6 is the second distance shorter than the first distance, S represents the area of the mold 3, and α represents a predetermined weighting coefficient (a positive real number smaller than 1). For example, α=1/2 can be set.

With the above control processing, it is also possible to obtain the same effects as in the first embodiment.

### Third Embodiment

The arrangement of an imprint apparatus according to the third embodiment is almost the same as in the second embodiment. However, in this embodiment, a gas mixture containing a condensable gas 21 (for example, 1,1,1,3,3-pentafluoropropane) and a permeable gas 22 (a gas falling outside the definition of the condensable gas, for example, helium gas) is used. A load imposed on a mold 3 is measured using a load cell 33, and it is determined based on the measure load whether a condition is satisfied. The condition is given by:

α·(Pg1−Pf)/B1≧(A2−A1)/S (3)

where B1 represents the content of the condensable gas in the gas mixture, Pg1 represents the saturated vapor pressure of the condensable gas, Pf represents the pressure of an environment in which the imprint apparatus is placed, A1 represents the load when the distance between the mold 3 and a substrate 6 is the first distance that is sufficiently long, A2 represents the load when the distance between the mold 3 and the substrate 6 is the second distance shorter than the first distance, S represents the area of the mold 3, and α represents a predetermined weighting coefficient (a positive real number smaller than 1). For example, α=1/2 can be set.

When mixing with a gas falling outside the definition of the condensable gas, an inert gas such as nitrogen gas or helium gas is mainly used. The type of gas and a mixing ratio can be selected for various reasons such as a further decrease in global warming potential, control of physical property values such as a refractive index, and cost.

### Fourth Embodiment

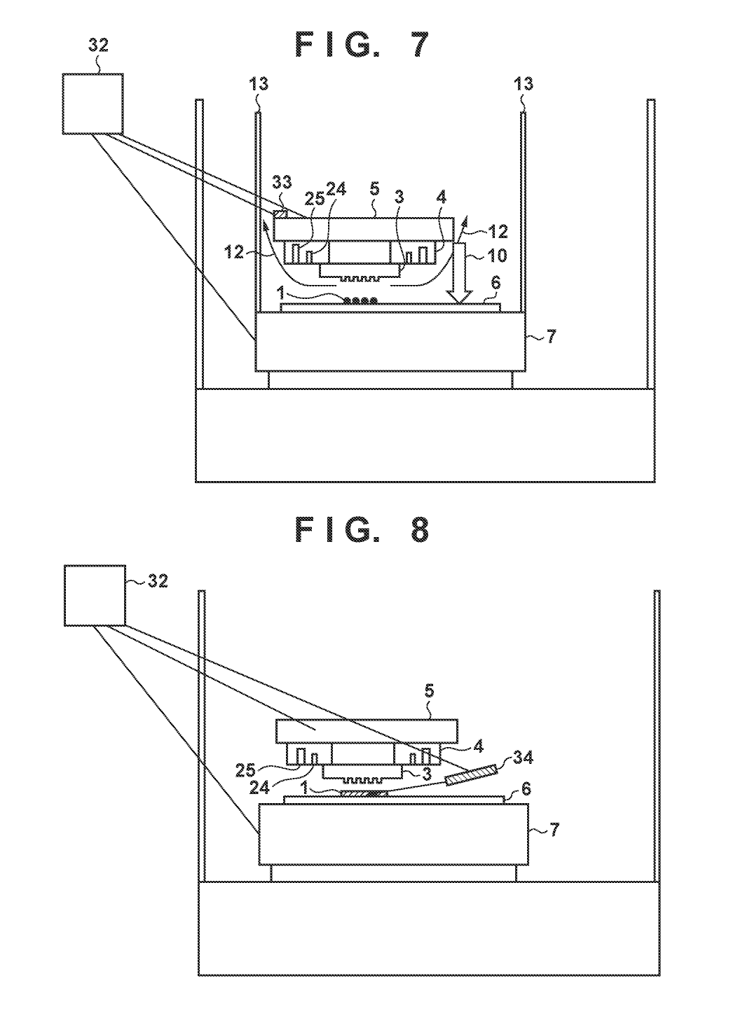

FIG. 7 is a view showing the arrangement of an imprint apparatus according to the fourth embodiment. The apparatus arrangement according to this embodiment is almost the same as in the second embodiment except that a wall 13 is provided to surround a space in an imprint region. The wall 13 is provided for the purpose of stabilizing the gas density in an imprint environment, improving the gas recovery efficiency, and preventing particles and impurities from entering. Note that the wall 13 may be formed by a structure or a gas flow like an air curtain. In this embodiment, when a mold 3 is brought closer to a substrate 6 by moving a mold head 5 by a driving device 5a in a direction indicated by an arrow 10, the gas is pushed out, as indicated by arrows 12, thereby generating a pressure for preventing the mold 3 from being brought closer to the substrate 6. Since the gas indicated by the arrows 12 flows into a region narrower than that in the case of the arrows 11 (FIGS. 4 and 5) in the above-described first to third embodiments, it becomes difficult for the gas to flow, thereby causing the pressure to greatly rise. In this case as well, it is possible to control the pressure between the mold and the substrate using a load cell 33 by the same procedure as in the second or third embodiment.

### Fifth Embodiment

FIG. 8 is a view showing the arrangement of an imprint apparatus according to the fifth embodiment. The apparatus arrangement according to this embodiment is almost the same as that in the second embodiment except that an optical sensor 34 serving as an imaging device is provided to detect liquefaction of a condensable gas.

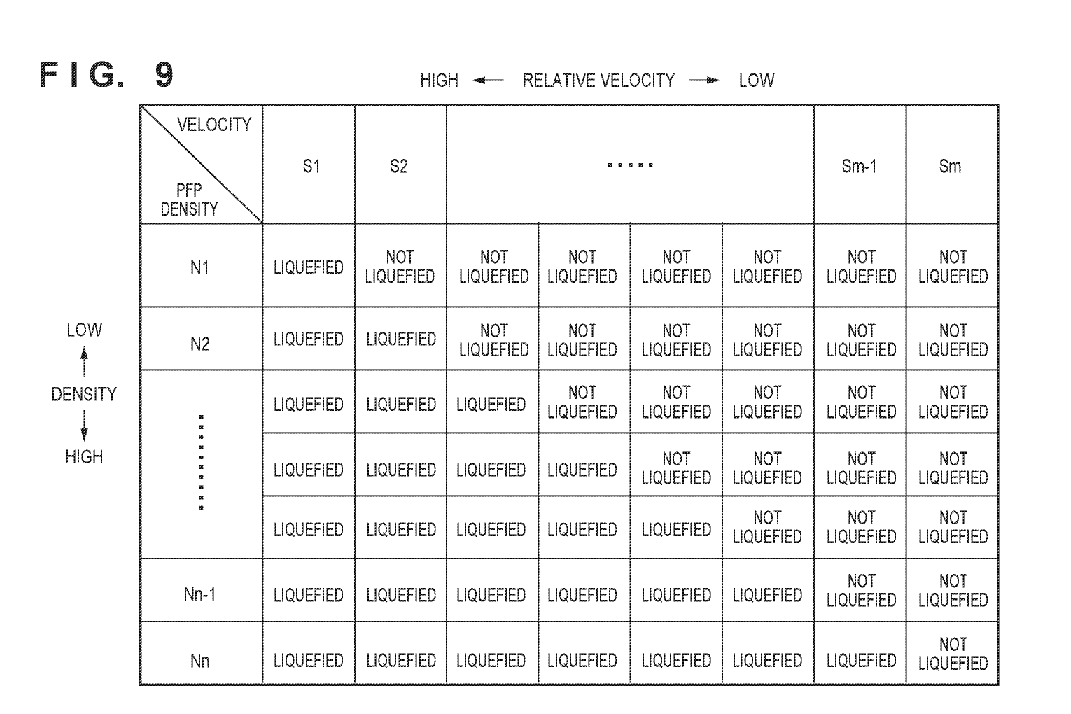

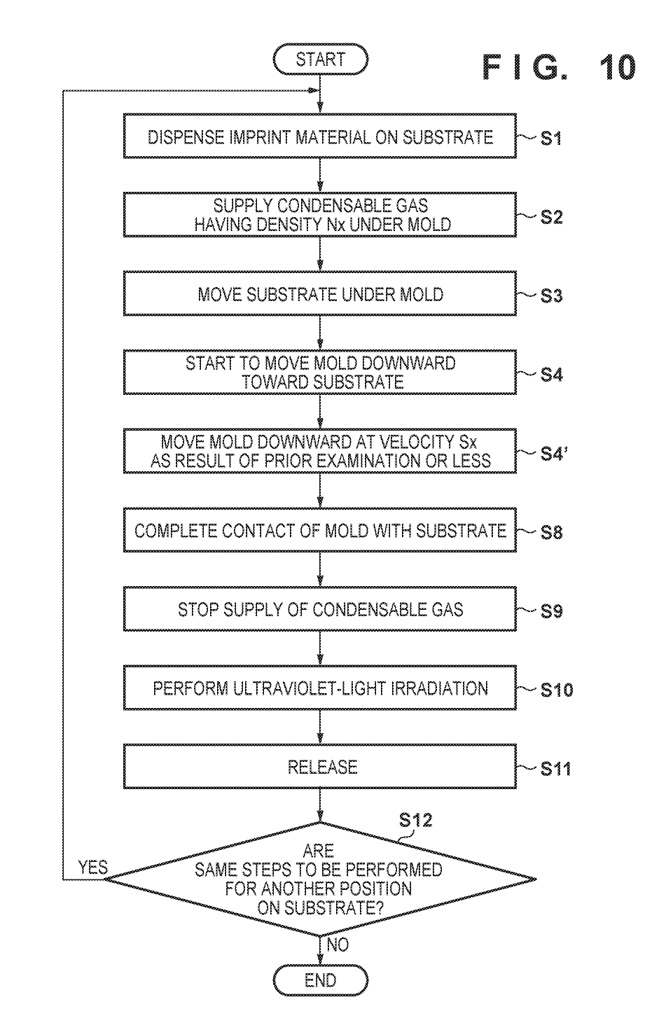

In this embodiment, as prior examination, imprint steps are performed by changing both a condensable gas density condition and a relative velocity condition. For example, imprint steps are performed under a condition of each of relative velocities S1, . . . , Sm between a mold 3 and a substrate 6 with respect to each of densities N1, . . . , Nn of the condensable gas. Each of the relative velocities S1, . . . , Sm may indicate a constant velocity or a velocity zone changing gradually. In the imprint steps under each condition, whether the condensable gas has been liquefied before the imprint material and the mold are brought into contact with each other is determined using the optical sensor 34. FIG. 9 shows examples of the determination result. Based on the determination result, it is possible to set, as a control target value corresponding to a density Nx of the condensable gas, a maximum relative velocity Sx that becomes the maximum relative velocity under the condition that the condensable gas is not liquefied before the imprint material and the mold are brought into contact with each other. That is, one of a plurality of candidates of the control target value, that minimizes the time taken to bring the mold into contact with the imprint material, is selected as the control target value.

Note that if the density of the condensable gas is fixed in advance, it is possible to perform the imprint steps by changing the relative velocity condition at the density. Alternatively, it is possible to determine liquefaction of the condensable gas using, as an imaging device, a camera provided in the imprint apparatus, an optical microscope, or an electron microscope, in place of the optical sensor 34.

The operation of the imprint apparatus according to this embodiment will be described below with reference to a flowchart shown in FIG. 10. For example, programs corresponding to this flowchart can be stored in a memory in a controller 32 or another storage device, and executed by the controller 32. Note that the same reference symbols as those in FIG. 2 of the first embodiment denote the same processing steps. First, an imprint material 1 is dispensed on the substrate 6 using a dispenser 2 (not shown in FIG. 8) (step S1). Next, a gas supply device 23 and a gas recovery device 29 (neither of which is shown in FIG. 8) are operated in parallel, thereby starting to supply and recover a condensable gas 21 having the density Nx with respect to a space under the mold 3 (step S2).

Subsequently, the substrate 6 is moved under the mold 3 by a substrate stage 7 (step S3), and the mold 3 starts to be moved downward toward the substrate 6 by a driving device 5a (not shown in FIG. 8) of a mold head 5 (step S4). At this time, by using the mold head 5, the mold 3 is brought closer to the substrate 6 at the maximum relative velocity Sx obtained by prior examination or less (step S4′). After contact of the mold 3 with the substrate 6 is completed (step S8), supply of the condensable gas is stopped (step S9), and an illumination system 40 (not shown in FIG. 8) performs ultraviolet-light irradiation to cure the imprint material 1 (step S10). After that, the pattern of the imprint material 1 is formed by releasing the mold 3 from the imprint material 1 (step S11). Subsequently, it is determined whether to perform the above-described imprint steps in steps S1 to S11 for another position on the substrate (step S12). Repeating the imprint steps molds the imprint material 1 on the entire surface of the substrate 6.

### Sixth Embodiment

In the above-described fifth embodiment, by using the optical sensor 34 serving as an imaging device, a camera, an optical microscope, an electron microscope, or the like, it is determined whether the condensable gas has been liquefied before the imprint material and the mold are brought into contact with each other. However, liquefaction of a condensable gas may be determined by another method. For example, if the condensable gas is liquefied, an increase in surface roughness of an imprint material, a decrease in thickness of the imprint material, a reduction in elastic modulus of the imprint material, and the like can be observed. Therefore, liquefaction of the condensable gas may be determined using at least one of the dimension (for example, the thickness of the imprint material) of a pattern formed by the imprint material on a substrate in the imprint steps, the shape, the surface roughness, the elastic modulus of the imprint material, and the like.

### Seventh Embodiment

It is possible to determine liquefaction of a condensable gas by still another method. An imprint apparatus according to the seventh embodiment has, for example, the arrangement shown in FIG. 4, similarly to the first embodiment. In this embodiment, the pressure (air pressure) between a mold 3 and a substrate 6 before the mold 3 is brought into contact with an imprint material is measured using a pressure sensor 31 serving as a measuring device by changing both a condensable gas density condition and a relative velocity condition. If the condensable gas density is fixed in advance, imprint steps are performed by changing the relative velocity condition at the density. A pressure Px at which no liquefaction occurs at a condensable gas density Nx is obtained according to inequality (4) below, and a maximum relative velocity Sx at which the pressure is equal to or lower than the pressure Px is obtained based on the result.

α·(Pg−Pf)/Nx≧Px−Pf (4)

where Pg represents the saturated vapor pressure of the condensable gas, Pf represents the pressure of an environment in which the imprint apparatus is placed, Px represents the pressure detected by the pressure sensor 31, that is, the pressure between the mold 3 and the substrate 6 before the mold 3 is brought into contact with the imprint material, and α represents a predetermined weighting coefficient (a positive real number smaller than 1). For example, α=1/2 can be set. After the maximum relative velocity Sx at the density Nx is obtained, the imprint steps are performed according to the procedure shown in FIG. 10, thereby molding the imprint material 1 on the entire surface of the substrate 6.

### Eighth Embodiment

An imprint apparatus according to the eighth embodiment has, for example, the arrangement shown in FIG. 5, similarly to the second embodiment. For example, if a condensable gas density is fixed in advance, a load imposed on a mold 3 is measured using a load cell 33 serving as a measuring device by changing a relative velocity condition at the density. A load (Ax−A1) at which no liquefaction occurs at a condensable gas density Nx is obtained according to inequality (5) below, and a maximum relative velocity Sx at which the load is equal to or smaller than a load Ax is obtained based on the result.

α·(Pg1−Pf)/Nx≧(Ax−A1)/S (5)

where Pg1 represents the saturated vapor pressure of a condensable gas, Pf represents the pressure of an environment in which the imprint apparatus is placed, A1 represents the load when the distance between the mold 3 and a substrate 6 is the first distance that is sufficiently long, Ax represents the load when the distance between the mold 3 and the substrate 6 is the second distance shorter than the first distance, S represents the area of the mold 3, and α represents a predetermined weighting coefficient (a positive real number smaller than 1). For example, α=1/2 can be set. After the maximum relative velocity Sx at the density Nx is obtained, imprint steps are performed according to the procedure shown in FIG. 10, thereby molding the imprint material 1 on the entire surface of the substrate 6.

### Ninth Embodiment

An imprint apparatus according to the ninth embodiment may have any of the arrangements shown in FIGS. 1, 4, 5, 7, and 8. Assume that the imprint apparatus has the arrangement shown in FIG. 5, similarly to the second embodiment. When Hm represents the relative distance between a mold 3 and a substrate 6, the mold 3 is moved downward at a maximum relative velocity settable in the imprint apparatus used in this embodiment until the relative distance becomes close to a predetermined distance, for example, a relative distance Hm/β, (β, is a real number larger than 1). At this time, it is confirmed that a condensable gas has not been liquefied, by using the method according to the fifth to eighth embodiments. Furthermore, based on the relative distance Hm/β, a maximum relative velocity Sx is obtained using the method according to the fifth to eighth embodiments by changing both a condensable gas density condition and a relative velocity condition. If the condensable gas density is fixed in advance, the maximum relative velocity Sx is obtained by changing the relative velocity condition at the density. Until the relative distance changes from Hm to Hm/β, the mold 3 is moved downward at the maximum relative velocity settable in the imprint apparatus used in this embodiment. After the maximum relative velocity Sx at which no liquefaction occurs at the density Nx is obtained based on the relative distance Hm/β, imprint steps are performed according to the procedure shown in FIG. 10, thereby molding an imprint material 1 on the entire surface of the substrate 6. According to this embodiment, a control target value concerning the relative velocity when the distance between the mold 3 and the imprint material is equal to or shorter than a predetermined value is set.

<Modification>

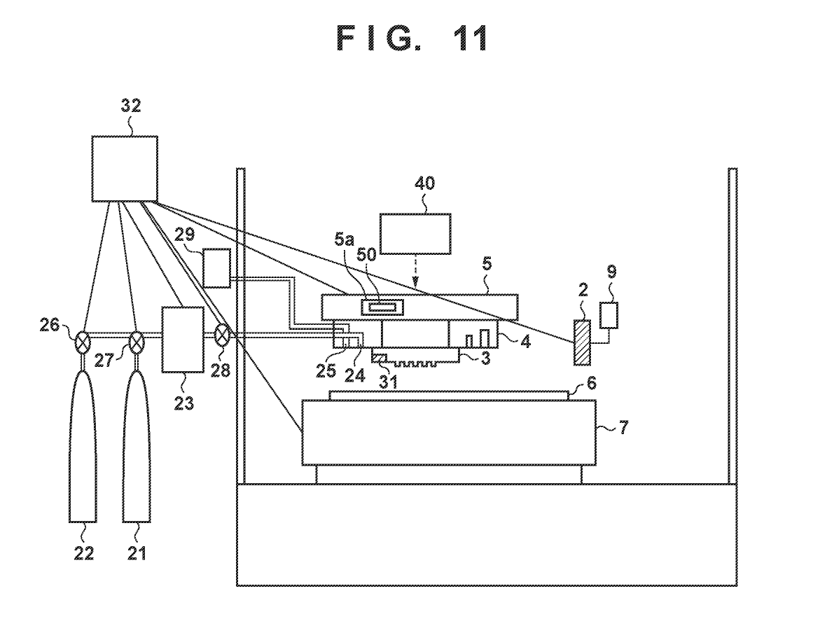

FIG. 11 is a view showing a modification of the imprint apparatus. Referring to FIG. 11, a driving device 5a includes an air pressure adjustment mechanism 50 having a function of adjusting the air pressure of a space that is a space (cavity) surrounded by a mold head 5 and a mold 3 and also serves as the optical path of ultraviolet light from an illumination system 40. It is possible to deform the mold 3 held by the mold head 5 in a convex shape toward a substrate 6 by setting the air pressure in the cavity to a positive one using the air pressure adjustment mechanism 50. If the mold head 5 is moved downward in this state, the distal end of the convex portion of the mold 3 contacts an imprint material 1 first. After that, the air pressure in the cavity is changed to a zero pressure while further moving the mold head 5 downward. With this operation, the mold 3 is brought into contact with the imprint material 1 over the entire imprint region while pushing out the gas between the mold 3 and the substrate 6 (imprint material 1). It is thus possible to reduce confinement of bubbles between the substrate 6 (imprint material 1) and the mold 3. In this case, the control target value may include a value concerning a change in air pressure in the cavity, which causes no liquefaction (condensation) of the condensable gas before the mold 3 is brought into contact with the imprint material 1. The profile can be associated with the deformation rate of the mold, such as the change rate of the air pressure or the relationship between the air pressure and an elapsed time (time). Such control target value is preferably set or stored in advance. The control target value can be stored by associating it with the presence/absence of liquefaction for each condensable gas density, as shown in FIG. 9.

<Embodiment of Method of Manufacturing Article>

A method of manufacturing an article according to an embodiment of the present invention is suitable for manufacturing an article, for example, a microdevice such as a semiconductor device or an element having a microstructure. The method of manufacturing an article according to this embodiment includes a step of forming a pattern on an imprint material on a substrate by using an imprint apparatus (a step of performing an imprint process on the substrate), and a step of processing the substrate (the substrate having undergone the imprint process) on which the pattern is formed in the above step. The manufacturing method further includes other well-known steps (for example, oxidation, film formation, deposition, doping, planarization, etching, resist removal, dicing, bonding, and packaging). When compared to the conventional methods, the method of manufacturing an article according to this embodiment is advantageous in at least one of the performance, quality, productivity, and production cost of an article.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2014-248415, filed Dec. 8, 2014, and 2015-178879, filed Sep. 10, 2015, which are hereby incorporated by reference herein in their entirety.

What is claimed is:

1. An imprint apparatus for forming a pattern on a substrate by bringing a mold into contact with an imprint material on the substrate, the apparatus comprising:
a supply device configured to supply, between the imprint material and the mold, a condensable gas that is liquefied due to a rise in pressure caused by the contact; and
a controller configured to control a pressure of a gas between the imprint material and the mold before the contact so that the condensable gas between the imprint material and the mold is not liquefied before the contact.

2. The apparatus according to claim 1, further comprising:
a detector configured to detect the pressure of the gas between the mold and the substrate,
wherein the controller is configured to control a relative velocity between the mold and the substrate based on an output of the detector.

3. The apparatus according to claim 2, wherein the controller is configured to control the relative velocity so as to satisfy
α·(Pg−Pf)≧Pa−Pf
where Pa represents a saturated vapor pressure of the condensable gas, Pf represents a pressure of a gas in an environment of the imprint material, Pa represents a pressure detected by the detector, and α represents a coefficient that is a positive real number smaller than 1.

4. The apparatus according to claim 1, further comprising:
a detector configured to detect a load imposed on one of the mold and the substrate,
wherein the controller is configured to control a relative velocity between the mold and the substrate based on an output of the detector.

5. The apparatus according to claim 4, wherein the controller is configured to control the relative velocity so as to satisfy
α·(Pg−Pf)≧(A2−A1)/S
where Pg represents a saturated vapor pressure of the condensable gas, Pf represents a pressure of a gas in an environment of the imprint material, A1 represents the load in a case where a distance between the mold and the substrate is a first distance, A2 represents the load in a case where the distance between the mold and the substrate is a second distance shorter than the first distance, S represents an area of the mold, and α represents a coefficient that is a positive real number smaller than 1.

6. The apparatus according to claim 4, wherein
the supply device is configured to supply a mixing gas containing the condensable gas and another gas, and
the controller is configured to control the relative velocity so as to satisfy
α·(Pg1−Pf)/B1≧(A2−A1)/S
where B1 represents a content of the condensable gas in the gas mixture, Pg1 represents a saturated vapor pressure of the condensable gas, Pf represents a pressure of a gas in an environment of the imprint material, A1 represents the load in a case where a distance between the mold and the substrate is a first distance, A2 represents the load in a case where the distance between the mold and the substrate is a second distance shorter than the first distance, S represents an area of the mold, and α represents a coefficient that is a positive real number smaller than 1.

7. An imprint method of forming a pattern on a substrate by bringing a mold into contact with an imprint material on the substrate, the method comprising steps of:
supplying, between the imprint material and the mold, a condensable gas that is liquefied due to a rise in pressure caused by the contact; and
controlling a pressure of a gas between the imprint material and the mold before the contact so that the condensable gas between the imprint material and the mold is not liquefied before the contact.

8. A method of manufacturing an article, the method comprising steps of:
forming a pattern on a substrate using an imprint apparatus; and
processing the substrate, on which the pattern has been formed, to manufacture the article,
wherein the imprint apparatus forms the pattern on the substrate by bringing a mold into contact with an imprint material on the substrate, and includes
a supply device configured to supply, between the imprint material and the mold, a condensable gas that is liquefied due to a rise in pressure caused by the contact; and
a controller configured to control a pressure of a gas between the imprint material and the mold before the contact so that the condensable gas between the imprint material and the mold is not liquefied before the contact.

9. An imprint apparatus for forming a pattern on a substrate by bringing a mold into contact with an imprint material on the substrate, the apparatus comprising:
a supply device configured to supply, between the imprint material and the mold, a condensable gas that is liquefied due to a rise in pressure caused by the contact;
a driving device configured to move the substrate or the mold or both thereof for the contact; and
a controller configured to control the driving device,
wherein the controller is configured to control the driving device in accordance with a control target value corresponding to a density of the condensable gas.

10. The apparatus according to claim 9, wherein the controller is configured to set the control target value based on the density.

11. The apparatus according to claim 9, wherein the controller is configured to set, as the control target value, a control target value concerning a relative velocity between the imprint material and the mold before the contact.

12. The apparatus according to claim 11, wherein the relative velocity is that in a case where a distance between the imprint material and the mold is not larger than a predetermined value.

13. The apparatus according to claim 9, wherein
the driving device has a function of deforming the mold in a shape convex toward the substrate, and
the controller is configured to control the driving device in accordance with the control target value including a target value concerning a rate of the deformation.

14. The apparatus according to claim 9, wherein the controller is configured to set the control target value based on a result of determination of whether the condensable gas between the imprint material and the mold has been liquefied before the contact.

15. The apparatus according to claim 14, further comprising:
an imaging device configured to perform imaging of the substrate,
wherein the determination is performed based on the imaging by the imaging device.

16. The apparatus according to claim 15, wherein the imaging device includes a microscope.

17. The apparatus according to claim 14, wherein the determination is performed based on measurement concerning a dimension, shape, surface roughness, or elastic modulus or combination thereof of the pattern.

18. The apparatus according to claim 14, further comprising:
a measuring device configured to measure a gas pressure between the mold and the substrate,
wherein the determination is performed based on measurement by the measuring device.

19. The apparatus according to claim 14, further comprising:
a measuring device configured to measure a load imposed on the mold or the substrate or both thereof,
wherein the determination is performed based on measurement by the measuring device.

20. The apparatus according to claim 9, wherein the controller is configured to select, as the control target value, one of a plurality of candidates of the control target value, whose time required for the contact is minimized.

21. An imprint method of forming a pattern on a substrate by bringing a mold into contact with an imprint material on the substrate, the method comprising steps of:
supplying, between the imprint material and the mold, a condensable gas that is liquefied due to a rise in pressure caused by the contact; and
performing driving of moving the substrate or the mold or both thereof for the contact;
wherein the driving is controlled in accordance with a control target value with which the condensable gas between the imprint material and the mold is not liquefied before the contact.

22. The method according to claim 21, wherein the control target value corresponds to a density of the condensable gas.

23. The method according to claim 21, wherein as the control target value, a control target value concerning a relative velocity between the imprint material and the mold before the contact is set.

24. The method according to claim 23, wherein the relative velocity is that in a case where a distance between the imprint material and the mold is not larger than a predetermined value.

25. The method according to claim 21, wherein
the driving includes deforming the mold in a shape convex toward the substrate, and
the driving is controlled in accordance with the control target value including a target value concerning a rate of the deformation.

26. The method according to claim 21, wherein the control target value is set based on a result of determination of whether the condensable gas between the imprint material and the mold has been liquefied before the contact.

27. The method according to claim 26, wherein the determination is performed based on imaging of the substrate.

28. The method according to claim 27, wherein the imaging is performed by a microscope.

29. The method according to claim 26, wherein the determination is performed based on measurement concerning a dimension, shape, surface roughness, or elastic modulus or combination thereof of the pattern.

30. The method according to claim 26, wherein the determination is performed based on measurement of a gas pressure between the mold and the substrate.

31. The method according to claim 26, wherein the determination is performed by measurement of a load imposed on the mold or the substrate or both thereof.

32. The method according to claim 21, wherein one of a plurality of candidates of the control target value, whose time required for the contact is minimized, is selected.

33. A method of manufacturing an article, the method comprising steps of:
forming a pattern on a substrate using an imprint apparatus; and
processing the substrate, on which the pattern has been formed, to manufacture the article,
wherein the imprint apparatus forms the pattern on the substrate by bringing a mold into contact with an imprint material on the substrate, and includes
a supply device configured to supply, between the imprint material and the mold, a condensable gas that is liquefied due to a rise in pressure caused by the contact;
a driving device configured to move the substrate or the mold or both thereof for the contact; and
a controller configured to control the driving device,
wherein the controller is configured to control the driving device in accordance with a control target value corresponding to a density of the condensable gas.
